(19) United States
(12) Patent Application Publication
(10) Pub. No.: US 2023/0330454 A1
(43) Pub. Date: Oct. 19, 2023

(54) METHOD FOR PRODUCING A RESPIRATORY PROTECTION MASK

(71) Applicant: EUROFILTERS HOLDING N.V., Overpelt (BE)

(72) Inventors: Ralf SAUER, Overpelt (BE); Jan SCHULTINK, Overpelt (BE)

(21) Appl. No.: 18/020,727

(22) PCT Filed: Aug. 4, 2021
(86) PCT No.: PCT/EP2021/071712

§ 371 Date: Feb. 10, 2023

(30) Foreign Application Priority Data
Aug. 12, 2020 (EP) 20190686.4

(51) Int. Cl. A62B 23/02; A41D 13/11; B01D 39/16

(52) U.S. Cl. CPC A62B 23/025; A41D 13/1115; B01D 39/163; B01D 2239/0283; B01D 2239/0618; B01D 2239/0672; B01D 2239/0681; B01D 2239/10

(57) ABSTRACT

The invention relates to a method for producing a respiratory protection mask (1) comprising a filter material piece (2) made of an air-permeable material, comprising the steps of: providing a first non-woven material; compacting the first non-woven material in regions; bonding the first non-woven material to a second non-woven material in the compacted region.

The invention relates to a respiratory protection mask.

Respiratory protection masks regularly cover the mouth and nose of the wearer with a filter material and serve to protect the wearer from pollutants contained in the air and to protect the environment from exhaled bacteria and viruses. In this respect, the term includes, among others, in particular a mouth-nose protection, medical face masks and filtering half masks.

Nowadays, the filter material used generally consists of a non-woven made of plastic. Many respiratory protection masks are intended for single use and are disposed of afterwards.

When manufacturing or assembling respiratory protection masks, several layers of a non-woven are regularly joined together, often welded. Even if the connection of the non-woven layers is not subjected to particularly high stress, they still have to withstand certain minimum tearing forces without damage.

At the same time, due to the increasing demand for respiratory protection masks, it is necessary to be able to produce them efficiently in large quantities.

Therefore, the object of the invention is to provide a manufacturing process for respiratory protection masks that allows efficient production of large numbers of units while maintaining reliable stability of the respiratory protection masks.

This object is solved by the subject matter of claim 1.

According to the invention, there is provided a method for manufacturing a respiratory protection mask including a filter material piece made of an air-permeable material, including the steps of.
providing a first non-woven material,
compacting the first non-woven material in regions,
welding the first non-woven material to a second non-woven material in the compacted region.

Thus, the region, in which the two non-woven materials are welded, i.e., in the (later) welding region is compacted or pre-compacted in advance. It has been found that such a two-stage joining process results in high mechanical strength with short welding times. Thus, this process allows high cycle rates during production without sacrificing the strength of the welded joints.

With the welding of the non-woven materials, the filter material piece made of air-permeable material of the respiratory protection mask is obtained. The filter material piece forms the filter part of the respiratory protection mask, which is used to filter the inhaled and exhaled air.

For the purposes of the present invention, a “non-woven or non-woven fabric” means a random or tangled web that has undergone a reinforcement step (non-woven bonding step) so that it has sufficient strength to be wound or unwound into rolls, particularly by machine (i.e., on an industrial scale). The minimum web tension required for such winding is 0.044 N/mm. The web tension should not be higher than 10% to 25% of the minimum value of the maximum tensile force (according to DIN EN 29073-3:1992-08) of the material to be wound. This results for the maximum tensile force for a material to be wound in a minimum value of of 8.8 N per 5 cm strip width.

A fiber web corresponds to a tangled web, which, however, has not undergone a bonding step so that, unlike a non-woven, such a tangled web does not have sufficient strength to be wound or unwound into rolls by machine, for example.

In other words, the term “non-woven” is used as defined in ISO Standard ISO 9092:1988 or CEN Standard EN 29092. Details on the use of the definitions and/or processes described therein may also be found in the textbook “Non-wovens”, H. Fuchs, W. Albrecht, WILEY-VCH, 2012.

“Fibers” are understood to include both fibers of finite length (e.g., staple fibers) and fibers of theoretically infinite length, i.e., continuous fibers or filaments.

Before welding the two non-woven materials together, the second non-woven material may be compacted in certain regions. In principle, it is not necessary to pre-compact both non-woven materials to be joined together. However, this leads to a further improvement in strength or a further possible reduction in welding time. During welding, the compacted regions of the two non-woven materials then preferably lie over or on top of each other.

Compacting may be carried out by ultrasonic welding, thermal welding or by pressurization. The pressurization may be carried out in particular without further energy input, for example in the form of ultrasonic or thermal energy, i.e. at room temperature.

The non-woven materials may be welded by ultrasonic welding or thermal welding.

The area, in which region-wise compaction is carried out (pre-compaction region), may have the same dimensions, in particular in the plane of the non-woven material, as the (later) welding region. Preferably, the pre-compaction region may be larger than the welding region. This may ensure that, despite tolerances in the process parameters, the welding takes place in the pre-compacted region, so that, for example, the ultrasonic sonotrode for welding hits the pre-compacted region.

The two non-woven materials may be formed contiguously. In this case, they may be formed as a common piece of non-woven material. In this case, the welding is performed after folding or collapsing the single piece of non-woven material. In this case, if both non-woven materials are compacted in regions, the compacted regions are placed on top of or over each other.

According to an alternative, the two non-woven materials may be formed as separate or distinct pieces of material.

When formed as a continuous piece of non-woven material, the compaction in regions of both non-woven materials may be performed before or after folding or collapsing the single piece of non-woven material.

The first and/or the second non-woven material piece may be formed as a single layer or as multiple layers.

Each layer of the first and/or second non-woven material may be a non-woven or a fiber web. A fiber web is often used together with one or more non-woven layers in a multilayer composite or laminate. However, a multilayer non-woven material may also include only non-woven layers.

In a multi-layer structure of a non-woven material, the layers may be circumferentially welded together along the edges of the non-woven material (in the cut shape of the piece of filter material).

The non-woven materials may be dry-laid, wet-laid, or extrusion non-woven materials. Accordingly, the fibers of the non-woven materials may be of finite length (staple fibers), but may also be theoretically of infinite length (filaments). The non-woven layers may be, for example, a meltblown, spunbond and/or a spunblown non-woven. It may also be a nano-fiber non-woven (e.g., electrospun or extruded). A specific choice of the individual non-woven and its parameters allows a controlled adjustment of the filtering properties of the respiratory protection mask.

The term “nano-fiber” is used according to the terminology of DIN SPEC 1121:2010-02 (CEN ISO/TS 27687:2009).

The first non-woven material and/or the second non-woven material may be a three-layer laminate of a meltblown non-woven between two layers of a spunbond non-woven. Such an SMS laminate exhibits excellent filtration properties with high stability.

The first and/or the second non-woven material may include or consist of fibers of a virgin plastic and/or of a recycled plastic.

Thus, in addition to (pure or also called virgin) plastic material (primary material), such as virgin PP, fibers of the non-woven or fiber web may also be formed or made of a recycled plastic, such as rPP. In the latter case, the fibers are thus spun from the recycled plastic.

Recycled plastics are therefore plastics that have already been in use and have been recovered by appropriate recycling processes (secondary material). The resulting respiratory protection masks are advantageous from an ecological point of view, as they may be manufactured with a high degree of raw material neutrality.

The recycled plastic may be selected from the group consisting of recycled polyesters, in particular recycled polyethylene terephthalate (rPET), recycled polybutylene terephthalate (rPBT), recycled polylactic acid (rPLA), recycled polyglycolide and/or recycled polycaprolactone; recycled polyolefins, in particular recycled polypropylene (rPP), recycled polyethylene and/or recycled polystyrene (rPS); recycled polyvinyl chloride (rPVC), recycled polyamides, and mixtures and combinations thereof.

Relevant international standards exist for many plastic recyclates. For PET plastic recyclates, for example, DIN EN 15353:2007 is relevant. PS recyclates are described in more detail in DIN EN 15342:2008. PE recyclates are dealt with in DIN EN 15344:2008, PP recyclates are characterized in DIN EN 15345:2008. PVC recyclates are described in more detail in DIN EN 15346:2015. For the purpose of the corresponding special plastic recyclates, the present patent application adopts the definitions of these international standards. In this context, the plastic recyclates may be obtained from metallized or non-metallized raw materials. An example of non-metallized raw materials is plastic flakes or chips recovered from PET beverage bottles. Likewise, the raw materials may be metallized, for example, if they were obtained from metallic plastic films, especially metallized PET films (MPET).

The recycled plastic is in particular recycled polyethylene terephthalate (rPET) obtained, for example, from beverage bottles, in particular from so-called bottle flakes, i.e. pieces of ground beverage bottles.

Alternatively, the recycled plastic may be recycled polypropylene (rPP). The rPP may be either a physically or chemically recycled rPP material. Physically recycled rPP materials are obtained, for example, by physically separating PP material from waste, such as household waste. In particular, however, it is preferred that the rPP material is a chemically recycled material. In this regard, in embodiments, the rPP is produced by depolymerizing “virgin” PP in propane, dehydrogenating propane in propene, and then polymerizing the propene so produced. Compared to physically produced rPP material, chemically recycled rPP material has the advantage that the chemical and mechanical properties may be selectively adjusted as in the case of “virgin” PP. In particular, properties comparable to those of “virgin” PP may be achieved with chemically recycled rPP material. Also, in contrast to physically recycled rPP, material impurities may be avoided.

Processes for producing chemically recycled rPP are generally implemented on a large scale and are known in the prior art. In the depolymerization process, in embodiments, “virgin” PP from plastic waste (such as packaging materials) or waste oil is thermally and/or chemically processed and converted to propane. In particular, propane produced by depolymerization may be produced via Neste's NEXBTLTM technology. In the subsequent dehydrogenation process, the obtained propane is catalytically dehydrogenated and converted to propene. For example, in embodiments, dehydrogenation may be performed using the Oleflex process from UOP. In this process, a propane-containing gas is preheated to 600-700° C. and dehydrogenated in a fluidized bed dehydrogenation reactor on a platinum catalyst supported by alumina. In the polymerization step, the propene is polymerized to polypropylene, i.e. rPP. Conventional catalytic processes, such as Ziegler-Matta processes or metallocene-catalyzed processes, may be used. In particular, it is preferred that the rPP is a commercially available polypropylene produced according to Borealis' Ever Minds™ technology.

The recycled plastics, in particular the recycled PET and the recycled PP, in both the metallized and non-metallized versions, may be spun into the corresponding fibers, from which the corresponding staple fibers or meltblown or spunbond non-wovens may be produced for the purposes of the present invention. In particular, the use of chemically recycled rPP has the advantage that it may be processed into meltblown or spunbond non-wovens that have excellent properties. In this context, for example, it is very advantageous that meltblown or spunbond non-wovens made from this rPP material may be electrostatically charged particularly favorably. After corona treatment, an rPP material obtained in this way exhibits excellent adhesion to all other layers/materials of the present invention. In particular, this may be explained by the fact that the chargeability and charge persistence of such an rPP-based material are good and comparable to the properties of a material made from “virgin” PP.

In one embodiment, the fibers of one or more non-wovens or fiber webs included in one or both non-woven materials are formed from a single (virgin or recycled) plastic material.

Alternatively, however, it is equally possible for the fibers of one or more non-wovens or fiber webs to be formed from different plastic materials. These may be virgin and/or recycled plastics. Various embodiments are possible here:

On the one hand, a layer of a non-woven or fiber web may be a mixture of at least two fiber types made of different plastics, for example fiber mixtures formed from at least two different (virgin and/or recycled) plastics.

On the other hand, it is also possible for the non-woven or the fiber web to include bicomponent fibers (BiKo fibers) or to be formed therefrom. These may consist of a core, as well as a sheath enveloping the core. Core and sheath are formed from different plastics. In addition to core/sheath bicomponent fibers, the other common variants of bicomponent fibers (e.g. side by side) are also possible.

The bicomponent fibers may be present as staple fibers or be formed as an extrusion non-woven (for example, as meltblown, spunbond or spun-blown non-woven), so that the bicomponent fibers theoretically have infinite length and represent so-called filaments. In the case of such bicomponent fibers, it is possible for the core to be formed from a recycled plastic; for the sheath, for example, a virgin plastic may also be used, but alternatively another recycled plastic may also be used. Alternatively, the core and sheath may also be made of a virgin plastic.

One option is bicomponent fibers, whose core is made of recycled polyethylene terephthalate (rPET) or recycled polypropylene (rPP), and the sheath is made of polypropylene, which may be virgin or a recycled material.

When the bicomponent fibers are in meltblown, the sheath is preferably virgin material to be reliably and persistently electrostatically chargeable.

One or more of the non-woven layers of one or both non-woven materials may be electrostatically charged. Electrostatic charging of the non-woven layer may be accomplished by corona charging or hydrocharging. In particular, fibers formed from the chemically recycled rPP material described above, i.e., melt spun, thus allow for an ecologically advantageous embodiment with excellent filtration properties.

In the manufacturing processes described, the region-wise compaction and/or the welding may be carried out with a sonotrode and an anvil, with the sonotrode and/or the anvil having a smooth or a structured surface. For the welding step, a structuring (high-low structure) of the sonotrode and/or the anvil for having correspondingly relieved surface has proven to be particularly advantageous. A smooth surface on the sonotrode and anvil is particularly advantageous for region-wise compaction.

Before welding, a thermally reactivatable adhesive may be applied in certain regions, in particular in the compacted region. The thermally reactivatable adhesive may be a hot melt or welding varnish. Also in this case, the region of application corresponds to the (later) welding region.

After compaction or before welding, the adhesive may cool down. Welding would then reactivate the adhesive by melting it. The use of a reactivatable adhesive allows the required welding temperature to be chosen lower, since only the melting point of the adhesive may need to be reached, which is typically lower than that of the fibers.

The adhesive may be applied by means of a roller or a nozzle.

The manufacturing methods may further include attaching a fastening strap to the piece of filter material, wherein the attaching includes welding the fastening strap to the piece of filter material.

The attaching of the fastening strap may include compacting the fastening strap and/or the piece of filter material region by region, and welding the fastening strap to the piece of filter material in the compacted region. Thus, again, the two-step process may provide an increase in the number of cycles while maintaining good strength.

The at least one fastening strap may include or consist of a layer of a foil and/or a layer of a non-woven, for example a meltblown. The non-woven and/or the laminate of the two layers may be a crimped material (obtained, for example, by the Micrex micro-creping process). Alternatively or additionally, the non-woven material may be Vistamaxx (manufacturer: ExxonMobil Chemical).

The at least one fastening strap may have a multilayer structure, wherein the fastening strap includes or consists of a layer of a foil and a layer of a non-woven, in particular a meltblown fabric.

In the case of a fastening strap in the form of a laminate including a foil and a non-woven, the foil, in particular in the form of a cast foil, may be laminated directly onto the non-woven. Thus, no additional adhesive is required.

The at least one fastening strap may include or be formed from a thermoplastic polymer, in particular a virgin or recycled thermoplastic polymer. In particular, the thermoplastic polymer may be a thermoplastic elastomer. For example, it may be thermoplastic polyurethane (TPU) or Vistamaxx. Thus, the fastening strap may be formed in the form of a laminate of a TPU foil and a TPU meltblown, TPU spunbond or TPU spun-blown. This structure results in good elasticity with high stability of the fastening strap. In addition, such a fastening strap may be welded to the filter material piece in an advantageous manner.

The fastening strap may be configured as a wound or twisted cord. This increases the wearing comfort. It is possible to prevent the twisting from twisting back again by means of thermal fixing (e.g. ultrasonic welding).

The respiratory protection masks described may include (exactly) two fastening straps.

One or more fastening straps may be configured to be guided around the back of a wearer's (user's) head. Alternatively, one or more fastening straps may be configured to be guided around an ear of a wearer (user).

The at least one fastening strap may be configured as a closed strap. This means that the corresponding fastening strap does not have a loose or open end. This may be achieved, for example, by both ends of a fastening strap being connected to the filter part or the filter material piece. Alternatively, for example, the corresponding strap may be closed as such; thus, it may have a ring or loop shape.

According to an alternative, the respiratory protection mask may have at least two, in particular four, fastening straps with open or loose ends. This means that (only) one end of each fastening strap is attached to the filter part or a non-woven material. The open/loose ends of two fastening straps each may be knotted.

The respiratory protection mask to be produced by the process may be a half mask. Thus, in use, it covers the nose, mouth and chin of the wearer. The respiratory protection mask may be a medical face mask according to DIN EN 14683:2019+AC:2019 or a filtering half mask according to DIN EN 149.

The invention further provides a respiratory protection mask obtained by a method according to any of the preceding claims.

The present invention will be explained in more detail by means of the following exemplary embodiments with reference to the figures, without limiting the invention to the specific embodiments shown. In the figures

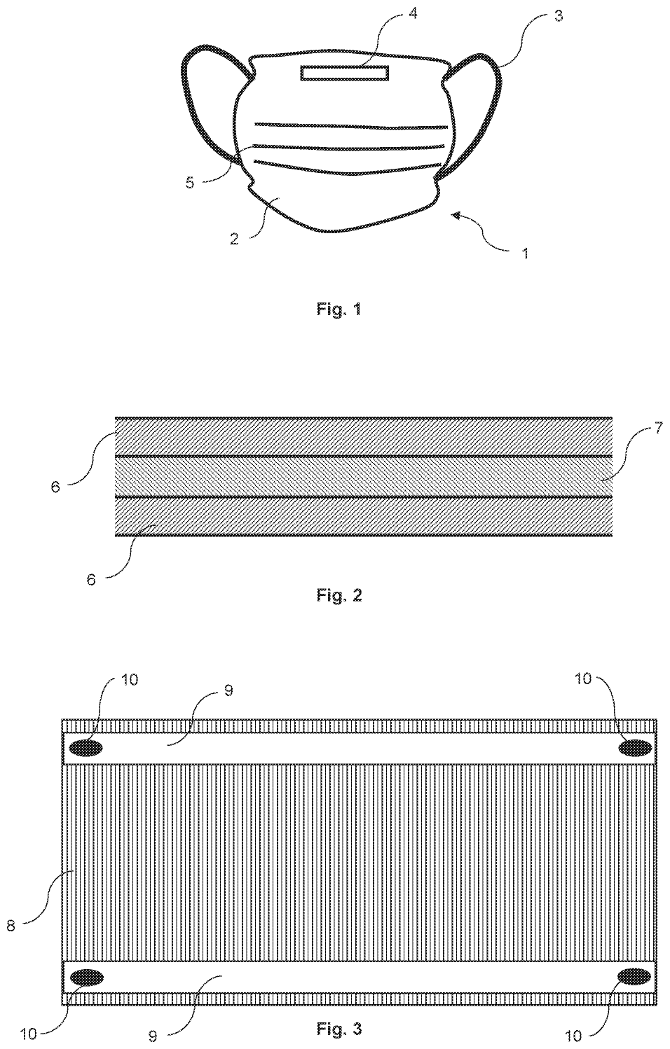

FIG. 1 is a schematic illustration of a respiratory protective mask,

FIG. 2 is a schematic cross-sectional view of the structure of a filter material piece of a respiratory protection mask,

FIG. 3 is a schematic top view of a respiratory protection mask,

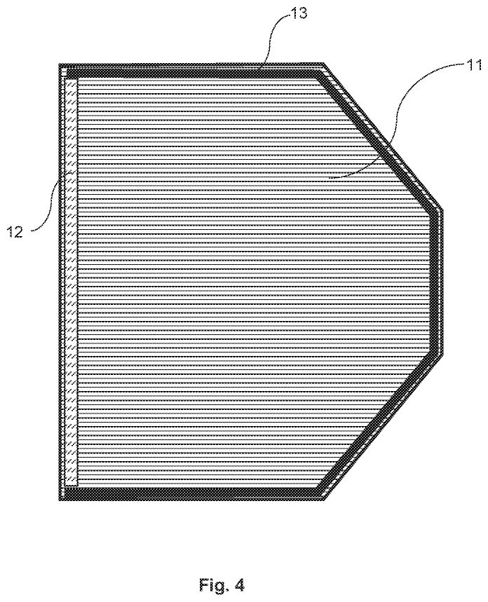

FIG. 4 a schematic side view of a filter piece of a respiratory protection mask.

FIG. 1 shows a schematic view of a respiratory protective mask 1 in the form of a half mask. This is an example of a medical face mask. The respiratory protection mask 1 shown includes a filter material piece or filter part 2. The cutting of the filter material piece is basically rectangular, but may also assume other shapes, in particular polygonal shapes.

In the example shown two fastening straps 3 are attached to the filter material piece 2. In the illustrated embodiment, the fastening straps are provided for fastening to the ears of the wearer.

For better adaptation to the shape of the face, the respiratory protection mask has a nose bridge 4 that is destructively or non-destructively detachably connected to the filter material piece. In particular, it may be a wire embedded in a plastic material.

A destructive connection includes, for example, a welding. This may be either continuous along the entire length of the nose bridge or at individual discrete points. Alternatively, the nose bridge may be bonded to the filter material piece. For example, a hot melt may be used for this purpose, which typically also results in a destructive connection.

In the embodiment, three pleats 5 are introduced into the filter piece or the air-permeable material 2.

The schematic cross-sectional view of FIG. 2 illustrates the structure of a filter material piece for a respiratory protection mask. A fine filter layer 7 is arranged between two support layers 6. The three layers of this non-woven material may be welded together, in particular along the edges, i.e. the circumference, of the filter piece 2, as illustrated in FIG. 1.

Alternatively to the structure shown in FIG. 2, the air-permeable material of the respiratory protection mask may include fewer or more layers. For example, only one support layer and one fine filter layer may be provided.

In one embodiment, the respiratory protection masks have one or more layers of virgin or recycled PET or PP filaments or virgin or recycled PET or PP staple fibers. Regarding the individual filter layers:

Spunbonded layers of PET or PP (virgin or recycled) with a basis weight of 5 to 50 g/m² and a titer of 1 dtex to 15 dtex are particularly suitable as support layers 6. The raw materials used for rPET are, for example, PET waste (e.g. punching waste) and so-called bottle flakes, i.e. pieces of ground beverage bottles. In order to cover the different coloration of the waste, it is possible to dye the recyclate. The HELIX® (Comerio Ercole) process is particularly advantageous as a thermal bonding process for consolidating the spunbond non-woven.

One or more layers of meltblown PET or PP (virgin or recycled) with a basis weight of 5 to 30 g/m² each are used as fine filter layers 7. Some or all of this (these) layer(s) is (are) electrostatically charged. Layers made of rPET or rPP may also be electrostatically charged. The only thing to keep in mind is that no metallized PET waste is then used for production. Alternatively, the meltblown filaments may also consist of bicomponent fibers, in which the core is made, for example, of rPET or rPP and the sheath is made of a plastic that may be particularly well electrostatically charged (e.g. virgin PP, PC, PET or rPP, in particular chemically recycled).

The filaments or staple fibers may also be made of bicomponent materials, in which the core is formed of rPET or rPP and the sheath is formed of a plastic that may be particularly well electrostatically charged (e.g. virgin PP, PC, PET or rPP).

Specifically, the filter material piece may be made of a three-layer air-permeable material. In this case, a meltblown non-woven layer with a grammage of 20 g/m² is arranged between two spunbond non-woven layers of virgin PET or rPET, The SMS thus obtained may be ultrasonically welded by a weld seam running along the edges.

The meltblown may be electrostatically charged by the addition of additives and a water jet treatment (hydrocharging), as described for example in WO 97/07272.

Alternatively, the meltblown may have a grammage of 25 g/m² and have been electrostatically charged by means of a corona treatment.

The meltblown may include bicomponent fibers having a core of rPP and a sheath of virgin PP. Alternatively, the sheath may also include rPP. The meltblown may be produced, for example, with a meltblown machine from Hills Inc. of West Melbourne, FL, USA. This allows high recycled content to be achieved despite electrostatic charging.

The SMS may be creped. To this end, in particular, the Micrex micro-creping process may be used. Purely by way of example, reference is made to WO 2007/079502. The increase in surface area achieved in this way not only results in a softer appearance, but it may also be better adapted to the shape of the face and absorbs moisture more efficiently.

The multilayer air-permeable material may be joined by means of a two-step process—as described above. In this process, one, several or all non-woven layers are pre-compacted region-by-region (in the later welding region) and then welded.

The compaction may be performed by ultrasonic welding, thermal welding or by pressurization. Welding of the non-woven layers may be carried out by ultrasonic welding or thermal welding.

FIG. 3 shows a schematic top view of an air-permeable material 8 corresponding to the filter part 2 of FIG. 1. However, in comparison with FIG. 1, FIG. 3 shows the rear side of the filter part, i.e. the side facing a user.

In the illustrated example, a fastening strap 9 is arranged on each of the opposite edges of the air-permeable material 8, extending over the entire length of the edge. The fastening straps may thus extend together with the air-permeable material during manufacture of the filter part and be cut together with the latter. In the example shown, the fastening strap and the air-permeable material are joined by means of a respective welding point 10 at the opposite end regions of each fastening strap 9.

For the fastening strap, for example, a TPU laminate consisting of a TPU foil with a thickness of 20 μm to 100 μm and a TPU meltblown (grammage: 20 to 80 g/m²) is used, which is welded to the filter material piece. The TPU used is in each case in the form of a plastic recyclate.

The ends of the fastening straps are also attached to the filter material piece in the two-stage process described above. First, the filter material piece in particular, and if necessary also the fastening straps, are pre-compacted in the regions to be welded later. For this purpose, the respective material is subjected to pressure or treated with ultrasound. This is followed by the actual welding step.

The PP material produced by the Vistamaxx process may be manufactured by the meltblown or foil casting or blown foil process and laminated—as described for the TPU laminate.

FIG. 4 shows a schematic side view of a filter part of a respiratory protection mask. The filter part includes two filter material pieces 11, only one of which is shown in FIG. 4.

Both pieces of filter material have a hexagonal shape and fit exactly on top of each other. Thus, the filter part formed by the filter material pieces 11 welded together also has a hexagonal shape as such (in the finished but unused state).

The edge on the left side lies between two right angles, and is thus bounded by two edges parallel to each other and perpendicular to the edge between them.

The air-permeable material of both filter material pieces is creped. The creping direction is also indicated here by the hatching; the creping folds extend substantially horizontally in the intended use of the respiratory protection mask made from the filter piece.

Each of the two filter material pieces 11 is configured in the form of an SMS, as explained, for example, in connection with FIG. 2. In this case, the three layers of a filter material piece have first been welded together along the edge between the two right angles, on the left side in the figure. The corresponding weld seam 12 of the filter material piece 11 shown extends in parallel to the left edge.

The weld seam 13 along the remaining five edges is a welding of connecting the two filter material pieces together. At these edges, there is no separate welding of the SMS layers of a filter material piece as such. On the side of the weld seam 12, however, the two filter material pieces are not welded together. This forms the open side of the respiratory protection mask, which will face the wearer's face.

During manufacture, therefore, the three layers of SMS in the form of non-woven webs are first laid loosely on top of each other and welded together along one edge by means of weld seam 12. The other five edges remain open, i.e. the layers are loose. In the arrangement shown in FIG. 4, the machine direction of the production machine extends from top to bottom, parallel to the weld seam 12. The SMS filter material web welded on one side only is then creped as a whole, the creping direction, i.e. the direction of the crepe folds, being transverse, i.e. essentially perpendicular to the machine direction or weld seam 12.

Subsequently, two such creped SMS filter material webs are arranged over each other in the machine direction, i.e. in the direction of or parallel to the weld seam 12, so that they come to lie on top of each other. The two SMS filter material webs, i.e. the total of six layers of two SMS, are welded together along weld seam 13, which forms five edges of the two superimposed filter material pieces. Along these edges, the two filter material webs are punched, so that a filter part 11 is then obtained as shown in FIG. 4.

The two SMS filter material webs, i.e. the two non-woven materials, are welded together using the two-stage process. The region with the reference sign 13 is first pre-compacted. In this example, pre-compaction is performed by pressurization at room temperature. A thermal or ultrasonic welding device may be used for this purpose, with the latter merely compressing the non-woven material at room temperature without introducing thermal or ultrasonic energy. The additional introduction of thermal or ultrasonic energy during pre-compaction is also possible, whereby the corresponding total energy input by pre-compaction and welding is still lower in sum than a single-stage pure welding for a weld seam of the same strength. For example, the sum of pre-compaction time and welding time is less than would be required to achieve the same strength with a single-stage pure welding step.

An optional layer of hot melt may then be applied in the region, which is then allowed to cool. After cooling, thermal welding takes place, in which case only the melting temperature of the hotmelt needs to be reached. Alternatively, instead of applying hotmelt, only an ultrasonic welding step may take place.

The pre-compaction region is larger in the plane of the non-woven material than the later welding region. In particular, it may have a greater extension longitudinally and/or transversely to the machine direction. The larger pre-compaction region ensures that the subsequent application of thermal or ultrasonic energy falls within the pre-compacted region even if there are tolerances in the process parameters (e.g. fluctuations in the transport path between the pre-compaction station and the welding station, angular offset of the sonotrode, etc.).

The two-stage nature of the manufacturing process may be demonstrated microscopically, for example. A perfect match between the pre-compacted region and the welded region is virtually impossible to achieve, so that cross-sectional views regularly show a thickness jump between a sub-region that has only been pre-compacted and a welded region.

The resulting respiratory protection mask is advantageously stretchable, especially on its open side, i.e. in the area of the weld seam 12, which allows good face adaptation. In addition, due to the creping, the air permeability is also high and the breathing resistance is low.

Even though in the example described the filter material piece is composed of two non-woven materials, it is alternatively also possible to use two contiguous non-woven materials in the form of a common non-woven material piece. This is folded at the vertical edge located on the right in the figure, so that two hexagonal contiguous areas are then superimposed. The remainder of the two-stage welding process proceeds as described above.

Comparative tests have shown the advantages of such two-stage joining. A three-layer material was used, in which a meltblown non-woven layer with a basis weight of 33 g/m² was sandwiched between two spunbond non-woven layers with a basis weight of 35 g/m². The three-layer material was used as a single piece of non-woven material for manufacturing the mask; thus, two separate non-woven materials were not used.

In this comparative test, all layers consisted of virgin PP, but the same applies to recycled materials. These three layers were first pre-compacted by means of pressure in the later welding region, whereby the pre-compaction was only carried out on one side of the piece of material to be subsequently folded and superimposed.

Then the actual welding was carried out with the parameters given below. During welding, two sections of the coherent non-woven material lay one on top of the other, with one region being pre-compacted in the section lying above or below (non-woven material), but not in the section lying below or above, i.e. in the second non-woven material.

| | | | | |
|---|---|---|---|---|
| Welding time [ms] | 53 | 60 | 70 | 80 |
| Energy input [J] | 30 | 40 | 50 | 60 |
| Pressure [bar] | 1.8 | 1.8 | 1.8 | 1.8 |
| Strength [N] | 14.2 | 18.1 | 27.8 | 54.4 |

The diameter of the feed cylinder of the sonotrode, to which the pressure specification refers, is 80 mm.

It is evident that even at a welding time of 53 ms, the tensile strength of the welded joint is 14.2 N, which almost corresponds to the 15 N typically required for respiratory protection masks. Even with a welding time of 60 ms and a corresponding energy input of 40 J, the tensile strength is over 18 N.

In comparison, the welding time for the laminate without the pre-compaction with higher energy input is 320 ms:

| | |
|---|---|
| Welding time [ms] | 320 |
| Energy input [J] | 140 |
| Pressure [bar] | 2 |
| Strength [N] | 18.2 |

1. A method for producing a respiratory protection mask comprising a filter material piece made of an air-permeable material, comprising the steps of:
providing a first non-woven material,
compacting the first non-woven material in regions,
welding the first non-woven material to a second non-woven material in the compacted region.

2. The method according to claim 1, wherein before welding the two non-woven materials, the second non-woven material is compacted in regions.

3. The method according to claim 1, wherein the compacting is carried out by ultrasonic welding, thermal welding or by pressurization.

4. The method according to claim 1, wherein the welding of the non-woven materials is carried out by ultrasonic welding or thermal welding.

5. The method according to claim 1, wherein the two non-woven materials are formed contiguously.

6. The method according to claim 1, wherein at least one of the first and second non-woven materials have a single-layer structure or a multilayer structure.

7. The method according to claim 6 wherein each layer of the at least one of the first and second non-woven materials is a non-woven or a fiber web.

8. The method according to claim 1, wherein at least one of the first non-woven material and the second non-woven material is a three-layer laminate of a meltblown non-woven material between two layers of a spunbond non-woven material.

9. The method according to claim 1, wherein at least one of the first and the second non-woven material comprises or consists of fibers of a virgin plastic and/or of a recycled plastic.

10. The method according to claim 1, wherein the compacting in regions and/or the welding are performed with a sonotrode and an anvil, wherein the sonotrode and/or the anvil have a smooth surface or a textured surface.

11. The method according to claim 1, wherein a thermally reactivatable adhesive is applied in regions, in particular to the compacted region, before welding.

12. The method according to claim 11, wherein the adhesive is applied by means of with a roller or a nozzle.

13. The method according to claim 1, further comprising attaching a fastening strap to the filter material piece, wherein the attaching comprises welding the fastening strap to the filter material piece.

14. The method according to claim 13, wherein attaching the fastening strap comprises compacting the fastening strap and/or the filter material piece in regions, and welding the fastening strap to the filter material piece in the compacted region.

15. A respiratory protection mask obtained by the method according to claim 1.
